(19) United States
(12) Patent Application Publication
(10) Pub. No.: US 2026/0065725 A1
(43) Pub. Date: Mar. 5, 2026

(54) SYSTEM AND METHOD OF DETERMINING DIFFERENTIAL STATE OF A VEHICLE

(71) Applicant: NISSAN NORTH AMERICA, INC., Franklin, TN (US)

(72) Inventor: Adam Lee STREAN, Highland Township, MI (US)

(21) Appl. No.: 18/816,847

(22) Filed: Aug. 27, 2024

(51) Int. Cl. G07C 5/08; B60Q 9/00

(52) U.S. Cl. CPC G07C 5/0825; B60Q 9/00

(57) ABSTRACT

A control system is configured to determine a differential state of a vehicle. The control system includes a first wheel sensor, a second wheel sensor, and an electronic controller. The first wheel sensor is configured to detect a first wheel speed of a first wheel. The second wheel sensor is configured to detect a second wheel speed of a second wheel. The electronic controller is configured to determine whether the first wheel speed is equal to or different from the second wheel speed, and to turn off an indicator when the first wheel speed is different from the second wheel speed. The indicator is illuminated to indicate a locked differential state of the vehicle.

### BACKGROUND

### Technical Field

The present disclosure generally relates to a system and method of determining a differential state of a vehicle. More specifically, the present disclosure relates to a system and method of determining a differential state of a vehicle based on first and second wheel speeds.

### Background Information

A locking differential locks opposing wheels together such that the wheels rotate at the same speed. A locking mechanism moves from a first position in which the differential is unlocked, and a second position in which the differential is locked. When the locking differential is unlocked, a solenoid valve or a sensor detects that the locking mechanism is in the first position. When the locking differential is unlocked, the solenoid valve or the sensor detects that the locking mechanism is in the second position. The position of the locking mechanism is detected by the solenoid valve or the sensor to determine the operational state of the locking differential.

### SUMMARY

A need exists for a system and method of determining a differential state of a vehicle.

In view of the state of the known technology, one aspect of the present disclosure is to provide a control system configured to determine a differential state of a vehicle. The control system includes a first wheel sensor, a second wheel sensor, and an electronic controller. The first wheel sensor is configured to detect a first wheel speed of a first wheel. The second wheel sensor is configured to detect a second wheel speed of a second wheel. The electronic controller is configured to determine whether the first wheel speed is equal to or different from the second wheel speed, and to turn off an indicator when the first wheel speed is different from the second wheel speed. The indicator is illuminated to indicate a locked differential state of the vehicle.

Another aspect of the present disclosure is to provide a method of determining a differential state in a vehicle. A first wheel speed of a first wheel is detected. A second wheel speed of a second wheel is detected. A determination is made whether the first wheel speed is equal to or different from the second wheel speed. An indicator is turned off when the first wheel speed is different from the second wheel speed. The indicator is illuminated to indicate a locked differential state of the vehicle.

Also other objects, features, aspects and advantages of the disclosed system and method of determining an unlocked differential state of a vehicle will become apparent to those skilled in the art from the following detailed description, which, taken in conjunction with the annexed drawings, discloses exemplary embodiments of the system and method of determining an unlocked differential state of a vehicle.

### BRIEF DESCRIPTION OF THE DRAWINGS

Referring now to the attached drawings which form a part of this original disclosure:

FIG. 1 is a top plan view of a vehicle in accordance with an exemplary embodiment;

FIG. 2 is a schematic diagram of the vehicle of FIG. 1 including the control system in accordance with the exemplary embodiment;

FIG. 3 is a perspective view of an instrument panel of the vehicle of FIG. 1;

FIG. 4 is an enlarged perspective view of the instrument panel of FIG. 3; and

FIG. 5 is a flowchart illustrating a method of determining a differential state of the vehicle of FIGS. 1 and 2.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

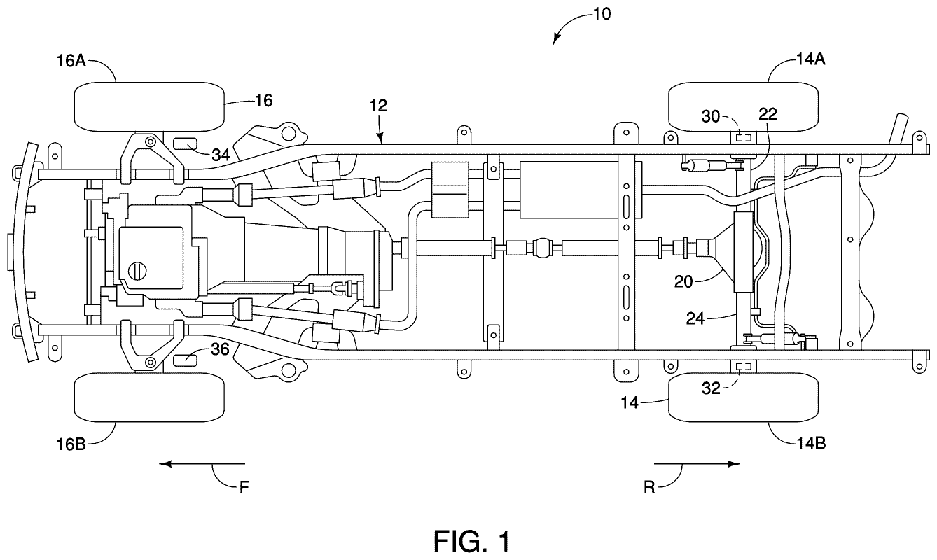

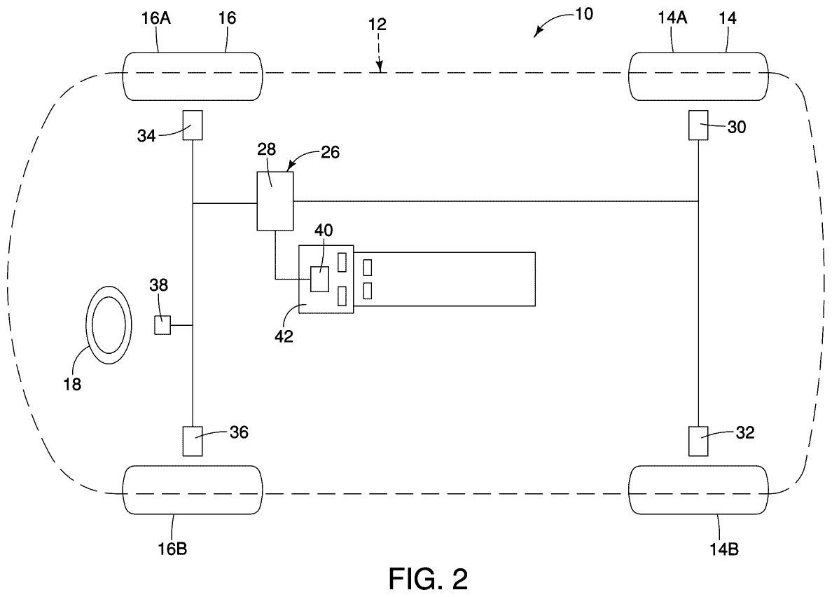

Referring initially to FIGS. 1 and 2, a vehicle 10 having frame 12 is illustrated in accordance with a first exemplary embodiment. Rear wheels 14 and front wheels 16 are rotatably connected to the frame 12 in a conventional manner. A steering wheel 18 is conventionally connected to the front wheels 16 such that rotation of the steering wheel causes pivotal movement of the front wheels 16. A forward direction and a rearward direction of the vehicle 10 are indicated by the F and R directional arrows, respectively, in FIG. 1.

A differential 20 receives a first rear axle 22 and a second rear axle 24, as shown in FIG. 1. A first rear tire 14A is connected to the first rear axle 22. A second rear tire 14B is connected to the second rear axle 24. The differential 20 is conventionally connected to the first and second rear axles 22 and 24 such that in a first, or unlocked, state of the differential, the first and second rear axles 22 and 24 are not locked together. When the differential 20 is locked, the first and second rear tires 14A and 14B rotate at the same speed because the first and second rear axles 22 and 24 are locked together. In a second, or locked, state of the differential, the first and second rear axles 22 and 24 are locked together. When the differential 20 is unlocked, the first and second rear tires 14A and 14B rotate at different speeds because the first and second rear axles 22 and 24 are not locked together. The differential 20 includes a conventional locking mechanism configured to move between the locked position and the unlocked position.

A differential state determination system 26 is configured to determine a differential state of the differential 20, as shown in FIG. 2. The differential state determination system 26 includes an electronic controller 28 that is connected to and/or is in electronic communication with various systems and components of the vehicle 10, as shown in FIG. 2.

The vehicle 10 includes a vehicle dynamic control (VDC) monitoring system control program. The VDC system is a conventional control system configured to maintain longitudinal and lateral stability of the vehicle 20. The electronic controller 28 preferably includes a microcomputer that communicates with the VDC system. The electronic controller 28 can also include other conventional components, such as an input interface circuit, an output interface circuit, and storage devices, such as a ROM (Read Only Memory) device and a RAM (Random Access Memory) device and electronic storage devices or drives (all hereinafter referred to collectively as electronic memory). The microcomputer of the electronic controller 28 is programmed to control the vehicle dynamic control monitoring system and the differential state determination system 26. The memory circuit stores processing results and control programs, such as ones for the vehicle dynamic control monitoring system operations and the differential state determination system 28 that are run by the processor circuit. The electronic controller 28 is operatively coupled to the various vehicle components and components of the vehicle dynamic control monitoring system in a conventional manner. The internal RAM of the electronic controller 28 stores statuses of operational flags and various control data. The internal ROM of the electronic controller 28 stores data communication protocols and commands for various operations. The electronic controller 28 is capable of selectively controlling any of the components of the control system of the vehicle dynamic control monitoring system and the differential state determination system 26 in accordance with the control program. It will be apparent to those skilled in the art from this disclosure that the precise structure and algorithms for the electronic controller 28 can be any combination of hardware and software that will carry out the functions of the vehicle dynamic control monitoring system and the differential state determination system 26.

The electronic controller 28 is configured to perform a plurality of tasks and operations, and is programed to evaluate and process data from the various sensors and systems connected thereto, along with data relating to various on-road and off-road conditions, such as those described below.

The vehicle 10 includes a first rear wheel speed sensor 30 and a second rear wheel speed sensor 32. The first rear wheel speed sensor 30 is configured to detect a first wheel speed of the first rear wheel 14A. The second rear wheel speed sensor 32 is configured to detect a second wheel speed of the second rear wheel 14B. The first and second rear wheel speed sensors 30 and 32 are conventional sensors, and can be components of the VDC system. The first and second rear wheel speed sensors 30 and 32 are preferably disposed at a wheel end of each of the first and second rear axles 22 and 24, as shown in FIG. 1, although the first and second rear wheel speed sensors 30 and 32 can be disposed in any suitable location to determine wheel speeds of the rear wheels 14.

The first and second wheel speed sensors 30 and 32 are electronically connected to the electronic controller 28. The wheel speed detected by each of the first and second rear wheel speed sensors 30 and 32 is configured to be transmitted to the electronic controller 28.

First and second front wheel speed sensors 34 and 36 can be similarly disposed to determine wheels speeds of the first front wheel 16A and the second front wheel 16B, as shown in FIG. 1. The first and second front wheel speed sensors 34 and 36 are electrically connected to the electronic controller 28, as shown in FIG. 2. The wheel speed detected by each of the first and second front wheel speed sensors 34 and 36 is configured to be transmitted to the electronic controller 28. The first and second front wheel speed sensors 34 and 36 are conventional wheel speed sensors. The first and second front wheel speed sensors 34 and 36 are preferably disposed at a wheel end of the front axles, although the first and second front wheel speed sensors can be disposed in any suitable location to detect the wheel speeds of the first and second front wheels 16A and 16B.

The steering wheel 18 is operatively connected to the first and second front wheels 16A and 16B to transmit rotational movement of the steering wheel 18 to the first and second front wheels 16A and 16B. A steering wheel sensor 38 is conventionally mounted, such as fixed onto a steering column, to detect a rotation, or steering, angle of the steering wheel 18. The steering wheel sensor 38 is electrically connected to the electronic controller 28 to transmit a detected steering angle of the steering wheel 18 to the electronic controller 28. The steering wheel sensor 38 is a conventional steering angle sensor.

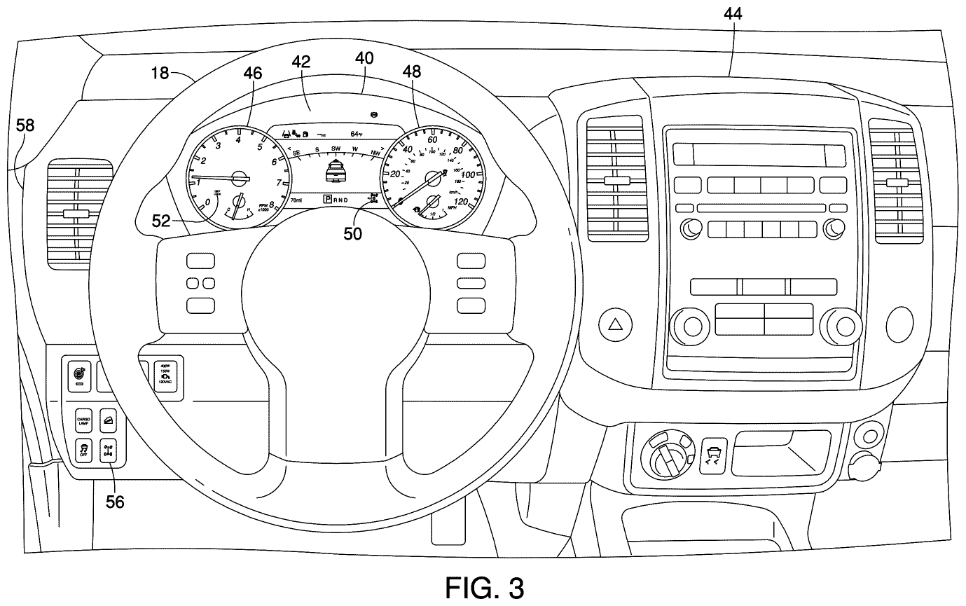

The differential state determination system 26 can further include a display 40 and an instrument cluster 42, as shown in FIGS. 2 and 3. The display 40 can be a video monitor or touch screen display installed to an instrument panel within the passenger compartment of the vehicle 10 in a location easily observed by the vehicle operator. The display 40 can be part of the instrument cluster 42 or can be installed at a location spaced apart from the instrument cluster 42, such as part of the infotainment system 44.

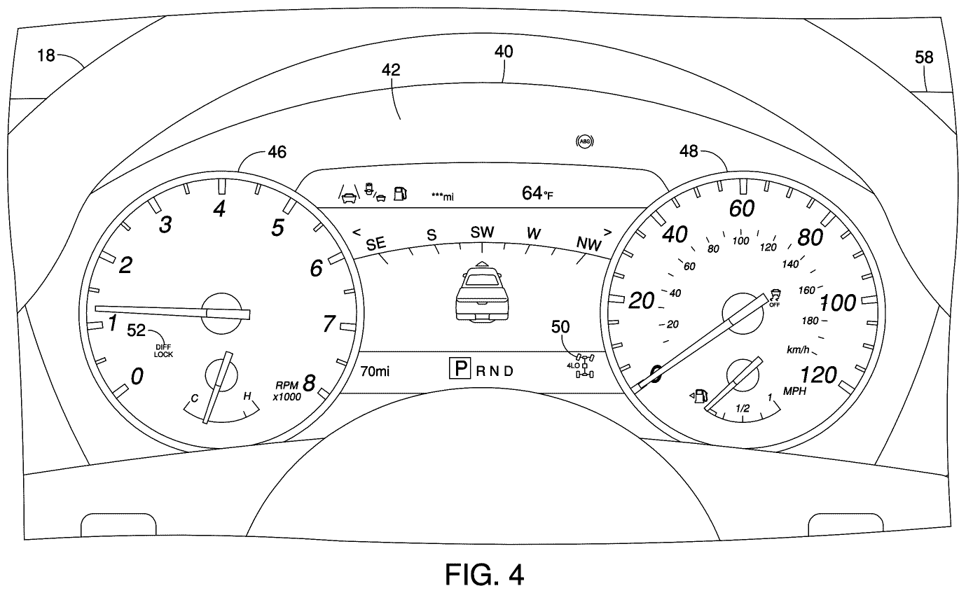

The instrument cluster 42, as shown in FIGS. 3 and 4, includes a speedometer 46, a tachometer 48, a first lamp 50, and a second lamp 52. The first lamp, or indicator, 50 is illuminated in response to the four-wheel drive (4WD) system being activated. As shown in FIGS. 3 and 4, the first lamp 50 is illuminated to indicate that the four-wheel drive system is in the 4WD low (4WD LO) setting. The first lamp 50 can be disposed in any suitable location, such as on the display 40 of the instrument cluster 42. The second lamp, or indicator, 52 is illuminated to indicate that the differential 20 is in the locked state. As shown in FIGS. 3 and 4, the second lamp 52 is illuminated to indicate that the differential 20 is in the locked state (e.g., “DIFF LOCK”). In other words, the second lamp is illuminated to indicate a locked differential state of the vehicle 10. The second lamp 52 can be disposed in any suitable location, such as on the speedometer 46. The display 40 and the instrument cluster 42 are electrically connected to the electronic controller 28, as shown in FIG. 2.

The instrument cluster 42, as shown in FIGS. 3 and 4, includes a four wheel drive (4WD) knob 54 that is operated to control an operational mode of the 4WD system. The 4WD knob 54 is operable to set a two-wheel drive, a 4WD high, and a 4WD low state of the 4WD system. The first lamp 50 is illuminated to indicate the current 4WD operating state of the vehicle 10.

The instrument cluster 42, as shown in FIGS. 3 and 4, includes a locking differential switch, or button, 56 that is operated to cause the differential 20 (FIG. 1) to lock the first and second rear wheels 14A and 14B such that the first and second rear wheels 14A and 14B turn at the same speed. The locking differential switch 56 is pushed to lock the differential 20. The locking differential switch 56 is pushed again from the locked differential state to unlock the differential 20. The second lamp 52 is illuminated to indicate the locked state of the differential 20. The second lamp 50 is not illuminated when the differential is in the unlocked state. The instrument cluster 42 can include another locking differential switch that functions substantially similarly to the locking differential switch 56 to cause another differential to lock the first and second front wheels 16A and 16B. The locking differential switch 56 can be disposed in any suitable location of a dashboard 58, as shown in FIG. 3.

The detected first wheel speed is compared to the detected second wheel speed to determine the differential state of the differential 20. The electronic controller 28 is configured to determine whether the first wheel speed is equal to or different from the second wheel speed. Preferably, the first and second wheel speeds are compared over a predetermined amount of time, such as 0.5 seconds, to substantially prevent an instantaneous false positive. In other words, comparing the first and second wheel speeds for a difference over a predetermined amount of time substantially prevents an instantaneous wheel speed difference being indicative of the differential being unlocked. The electronic controller 28 is configured to turn off the second lamp 52, or indicator, when the first wheel speed is different from the second wheel speed. The first wheel speed being different from the second wheel speed indicates that the first and second axles 22 and 24 are not rotating together, such that the differential 20 is in the unlocked state. A difference in wheel speeds between the first and second rear wheels 16A and 16B can occur during, but is not limited to, wheel slip (e.g., when a driver hits the throttle hard) or when turning (e.g., left or right).

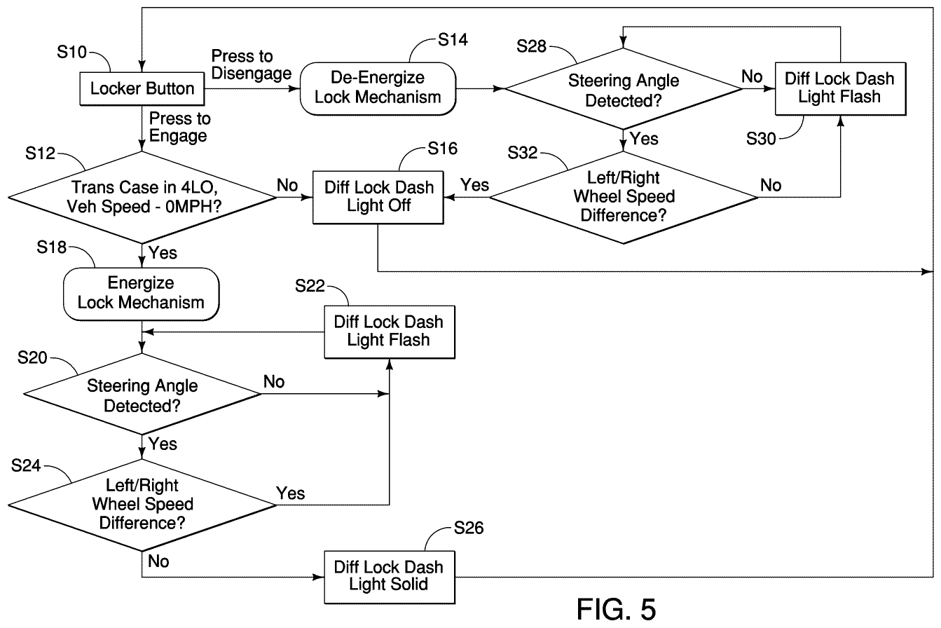

During operation of the vehicle 10, the electronic controller 28 of the differential state determination system 26 is configured to monitor the first wheel speed of the first rear wheel 14A and the second wheel speed of the second rear wheel 14B in accordance with the flowchart shown in FIG. 5. In step S10, the system determines whether the locking differential switch 56 is being pressed to engage or disengage the differential 20. When the locking differential switch 56 is pressed to engage the differential 20, the process moves to step S12. When the locking differential switch 56 is pressed to disengage the differential 20, the process moves to step S14.

In step S12 of FIG. 5, the electronic controller 28 determines whether the 4WD operational mode is in 4WD low (i.e., 4LO) and whether the vehicle speed is 0 mph (i.e., whether the vehicle is not moving). Alternatively, any suitable vehicle speed, such as 6 km/h) can be used to set the 4WD low mode. When both of these conditions are not met, i.e., either the vehicle is not operating in 4WD low or the vehicle speed is not equal to or less than the predetermined vehicle speed, the process moves to step S16. When both of these conditions are met, the process moves to step S18.

In step S16 of FIG. 5, the second lamp 52 is not illuminated because the conditions have not been met to lock the differential 20. The process ends, and returns to step S10.

In step S12 of FIG. 5, when the electronic controller 28 determines that the 4WD operational mode is in 4WD low and that the vehicle speed is 0 mph, the process moves to step S18. In step S18, the locking mechanism of the differential 20 is energized to move the differential to the locked state. The process moves to step S20.

In step S20 of FIG. 5, the electronic controller 28 determines the steering angle from the information transmitted by the steering angle sensor 38. When a steering angle is not detected (i.e., a steering angle of zero is detected), the electronic controller 28 determines that the vehicle 10 is traveling straight, and the process moves to step S22.

When the vehicle 10 is traveling straight (i.e., a zero degree turning angle), the first and second rear wheels 14A and 14B rotate at the same speed. When a steering angle is detected (i.e., a non-zero value), the vehicle 10 is determined to not be traveling straight, and the process moves to step S24. With a non-zero turning angle, the inside wheel rotates more slowly than the outside wheel due to the shorter radius being traveled by the inside wheel, thereby being indicative of the first and second wheel speeds being different.

In step S22 of FIG. 5, the second lamp 52 is caused to flash to indicate that the differential is in the process of engaging but is not yet in the locked state. The process moves to step S20 to determine the steering angle.

When a steering angle is determined, the process moves to step S24 of FIG. 5. The electronic controller 28 compares the first wheel speed and the second wheel speed based on information transmitted by the first rear wheel speed sensor 30 and the second rear wheel speed sensor 32. In other words, as shown in step S10 and S24, the electronic controller 28 is configured to determine whether the first rear wheel speed is equal to or different from the second rear wheel speed responsive to the locking differential switch 56 on the vehicle dashboard 58 being pressed. Preferably, the first and second wheel speeds are compared over a predetermined amount of time, such as 0.5 seconds, to substantially prevent an instantaneous false positive. When a difference between the first wheel speed and the second wheel speed over the predetermined amount of time is a non-zero value, the process moves to step S22 in which the second lamp 52 is caused to flash. A difference in the first and second wheel speeds indicates that the first and second axles 22 and 24 are not locked together, thereby indicating that the differential 20 is not yet in the locked state. The process returns to step S20 to determine whether a steering angle is detected. In other words, the electronic controller 28 is configured to flash the second lamp 52 after the locking differential switch 56 is pressed until the first rear wheel speed is determined to be the same as the second rear wheel speed (step S24).

When the electronic controller 28 determines there is no difference between the first wheel speed and the second wheel speed in step S24, the process moves to step S26. Determining that there is no difference between the first wheel speed and the second wheel speed indicates that the first and second axles 22 and 24 are locked together as the first and second rear wheels 14A and 14B are rotating at the same speed. In step S26, the second lamp 52 is illuminated to indicate that the differential 20 is in the locked state. The process then returns to step S10. The electronic controller 28 is configured to maintain the second lamp 52 in the illuminated condition when the first rear wheel speed is the same as the second rear wheel speed until the locking differential switch 56 is pressed to disengage the differential 20, as shown in step S14 of FIG. 5.

In step S10 of FIG. 5, when the locking differential switch 56 is pressed to disengage the differential 20 (i.e., when the differential 20 is in the locked state), the process moves to step S14. In step S14, the electronic controller de-energizes the lock mechanism of the differential 20. The process then moves to step S28 in which the electronic controller 28 determines the steering angle from the information transmitted by the steering angle sensor 38. When a steering angle is not detected (i.e., a steering angle of zero is detected), the electronic controller 28 determines that the vehicle 10 is traveling straight. The process moves to step S30. When a steering angle is detected (i.e., a non-zero value), the vehicle 10 is determined to not be traveling straight, and the process moves to step S32.

In step S30 of FIG. 5, the second lamp 52 is caused to flash to indicate that the differential is in the process of disengaging but is not yet in the unlocked state. The process returns to step S28 to determine the steering angle.

When a steering angle is determined in step S28, the process moves to step S32 of FIG. 5. The electronic controller 28 compares the first wheel speed and the second wheel speed based on information transmitted by the first rear wheel speed sensor 30 and the second rear wheel speed sensor 32. Preferably, the first and second wheel speeds are compared over a predetermined amount of time, such as 0.5 seconds, to substantially prevent an instantaneous false positive. When a difference between the first wheel speed and the second wheel speed is a non-zero value, the process moves to step S16 in which the second lamp 52 is caused to turn off. A difference in the first and second wheel speeds indicates that the first and second axles 22 and 24 are not locked together, thereby indicating that the differential 20 is not yet in the locked state. The process moves to step S16 to turn off the second lamp 52 to indicate the differential is in the unlocked state. In other words, the locking differential state determination system determines that the differential 20 is in the unlocked state based on a detection of a steering angle (step S28) and a comparison of the first and second rear wheel speeds (step S32). The electronic controller 28 is configured to turn off the second lamp 52 when the steering angle is a non-zero angle (step S28) and the first rear wheel speed is different from the second rear wheel speed (step S32). From step S16, the process returns to step S10. In other words, the electronic controller 28 is configured to flash the second lamp 52 after the locking differential switch 56 is pressed until the first rear wheel speed is determined to be different from the second rear wheel speed (step S32).

When the electronic controller 28 determines there is no difference between the first wheel speed and the second wheel speed in step S32, the process moves to step S30. Determining that there is no difference between the first rear wheel speed and the second rear wheel speed indicates that the first and second axles 22 and 24 are locked together as the first and second rear wheels 14A and 14B are rotating at the same speed. In step S30, the second lamp 52 is caused to flash to indicate that the differential 20 is not yet in the unlocked state. In other words, the flashing second lamp 52 indicates that the differential is transitioning from the locked state to the unlocked state. The process then returns to step S28 to determine whether a steering angle is detected.

The locking differential state determination system illustrated in FIG. 5 is applicable to any opposed pair of wheels configured to be locked together by a differential. The locking differential state determination system 26 detects a differential state of the differential 20 based on a comparison of first and second wheel speeds without requiring an additional sensor or solenoid valve configured to detect a position of the locking mechanism.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the system and method of determining an unlocked differential state of a vehicle. Accordingly, these terms, as utilized to describe the present invention should be interpreted relative to a vehicle equipped with the system and method of determining an unlocked differential state of a vehicle.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired.

Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A control system for determining a differential state in a vehicle, the control system comprising:
a first wheel sensor configured to detect a first wheel speed of a first wheel;
a second wheel sensor configured to detect a second wheel speed of a second wheel; and
an electronic controller configured to
determine whether the first wheel speed is equal to or different from the second wheel speed, and
turn off an indicator when the first wheel speed is different from the second wheel speed, the indicator being illuminated indicating a locked differential state of the vehicle.

2. The control system according to claim 1, wherein
the electronic controller is further configured to maintain the indicator in an illuminated condition when the first wheel speed is equal to the second wheel speed.

3. The control system according to claim 1, wherein
a steering angle sensor is configured to detect a steering angle of a steering wheel.

4. The control system according to claim 3, wherein
the electronic controller is further configured to turn off the indicator when
the first wheel speed is different from the second wheel speed, and
the steering angle is a non-zero angle.

5. The control system according to claim 3, wherein
the first and second wheels are rear wheels of the vehicle.

6. The control system according to claim 1, wherein
the electronic controller is configured to determine whether the first wheel speed is equal to or different from the second wheel speed responsive to a button on a vehicle dashboard being pressed.

7. The control system according to claim 6, wherein
the electronic controller is further configured to flash the indicator after the button is pressed until the first wheel speed is determined to be different from the second wheel speed.

8. The control system according to claim 7, wherein
the electronic controller is further configured to maintain illumination of the indicator after the button is pressed until the first wheel speed is determined to be different from the second wheel speed.

9. The control system according to claim 1, wherein
the first wheel sensor is disposed at a wheel end of a first axle on which the first wheel is mounted, and the second wheel sensor is disposed at a wheel end of a second axle on which the second wheel is mounted.

10. The control system according to claim 3, wherein
the steering angle sensor is disposed on a steering column of the vehicle.

11. A method for determining a differential state in a vehicle, the method comprising the steps of:
detecting a first wheel speed of a first wheel;
detecting a second wheel speed of a second wheel;
determining whether the first wheel speed is equal to or different from the second wheel speed, and
turning off an indicator when the first wheel speed is different from the second wheel speed, the indicator being illuminated indicating a locked differential state of the vehicle.

12. The method according to claim 11, further comprising
maintaining the indicator in an illuminated condition when the first wheel speed is equal to the second wheel speed.

13. The method according to claim 11, further comprising
determining a steering angle of a steering wheel.

14. The method according to claim 13, further comprising turning off the indicator when
the first wheel speed is different from the second wheel speed, and
the steering angle is greater than zero.

15. The method according to claim 11, wherein
the first and second wheels are rear wheels of the vehicle.

16. The method according to claim 11, further comprising
pressing a differential button on a vehicle dashboard; and
determining whether the first wheel speed is equal to or different from the second wheel speed responsive to the differential button being pressed.

17. The method according to claim 16, wherein
flashing the indicator after the differential button is pressed until the first wheel speed is determined to be different from the second wheel speed.

18. The method according to claim 16, wherein
maintaining the indicator in an illuminated condition after the differential button is pressed until the first wheel speed is determined to be different from the second wheel speed.

19. The method according to claim 11, wherein
the first wheel sensor is disposed at a wheel end of a first axle on which the first wheel is mounted, and the second wheel sensor is disposed at a wheel end of a second axle on which the second wheel is mounted.

20. The method according to claim 13, wherein
the steering angle sensor is disposed on a steering column of the vehicle.
